(19) United States
(12) Patent Application Publication
(10) Pub. No.: US 2015/0077391 A1
(43) Pub. Date: Mar. 19, 2015

(54) PROJECTOR ELECTRODES FOR EXTENDING SENSITIVITY RANGE OF PROXIMITY SENSOR

(71) Applicant: CIRQUE CORPORATION, Salt Lake City, UT (US)

(72) Inventor: Jon Alan Bertrand, Taylorsville, UT (US)

(21) Appl. No.: 14/489,096

(22) Filed: Sep. 17, 2014

Related U.S. Application Data
(60) Provisional application No. 61/879,019, filed on Sep. 17, 2013.

(51) Int. Cl. G06F 3/041; G06F 3/044; G06F 3/046

(52) U.S. Cl. CPC G06F 3/0416; G06F 3/046; G06F 3/044; G06F 2203/04108
USPC 345/174

(57) ABSTRACT

A system and method for extending a sensitivity range of a touch and proximity sensor that uses mutual capacitance sensing, the system and method providing projecting electrodes that generate an electric field in a three dimensional volume of space above a touch and proximity sensor to thereby enable the touch and proximity sensor to accurately detect the presence of one or more objects at a greater distance as compared to a touch and proximity sensor that does not have the projecting electrodes to generate a stronger electric field.

### BACKGROUND OF THE INVENTION

1. Field Of the Invention

This invention relates generally to touch and proximity sensors. Specifically, the invention pertains to capacitance sensitive touch and proximity sensors that may perform touch and proximity sensing of one or more objects, and a means for increasing the sensitivity of the touch and proximity sensor in order to increase effectiveness of proximity sensing by increasing the strength of an electrical field in a three-dimensional volume above the touch and proximity sensor by using projector electrodes.

2. Description of Related Art

There are several designs for capacitance sensitive touch sensors. It is useful to examine the underlying technology to better understand how any capacitance sensitive touchpad may be modified to work with the present invention.

The CIRQUE® Corporation touchpad is a mutual capacitance-sensing device and an example is illustrated as a block diagram in FIG. 1. In this touchpad 10, a grid of X (12) and Y (14) electrodes and a sense electrode 16 is used to define the touch-sensitive area 18 of the touchpad. Typically, the touchpad 10 is a rectangular grid of approximately 16 by 12 electrodes, or 8 by 6 electrodes when there are space constraints. Interlaced with these X (12) and Y (14) (or row and column) electrodes is a single sense electrode 16. All position measurements are made through the sense electrode 16.

The CIRQUE® Corporation touchpad 10 measures an imbalance in electrical charge on the sense line 16. When no pointing object is on or in proximity to the touchpad 10, the touchpad circuitry 20 is in a balanced state, and there is no charge imbalance on the sense line 16. When a pointing object creates imbalance because of capacitive coupling when the object approaches or touches a touch surface (the sensing area 18 of the touchpad 10), a change in capacitance occurs on the electrodes 12, 14. What is measured is the change in capacitance, but not the absolute capacitance value on the electrodes 12, 14. The touchpad 10 determines the change in capacitance by measuring the amount of charge that must be injected onto the sense line 16 to reestablish or regain balance of charge on the sense line.

The system above is utilized to determine the position of a finger on or in proximity to a touchpad 10 as follows. This example describes row electrodes 12, and is repeated in the same manner for the column electrodes 14. The values obtained from the row and column electrode measurements determine an intersection which is the centroid of the pointing object on or in proximity to the touchpad 10.

In the first step, a first set of row electrodes 12 are driven with a first signal from P, N generator 22, and a different but adjacent second set of row electrodes are driven with a second signal from the P, N generator. The touchpad circuitry 20 obtains a value from the sense line 16 using a mutual capacitance measuring device 26 that indicates which row electrode is closest to the pointing object. However, the touchpad circuitry 20 under the control of some microcontroller 28 cannot yet determine on which side of the row electrode the pointing object is located, nor can the touchpad circuitry 20 determine just how far the pointing object is located away from the electrode. Thus, the system shifts by one electrode the group of electrodes 12 to be driven. In other words, the electrode on one side of the group is added, while the electrode on the opposite side of the group is no longer driven. The new group is then driven by the P, N generator 22 and a second measurement of the sense line 16 is taken.

From these two measurements, it is possible to determine on which side of the row electrode the pointing object is located, and how far away. Using an equation that compares the magnitude of the two signals measured then performs pointing object position determination.

The sensitivity or resolution of the CIRQUE® Corporation touchpad is much higher than the 16 by 12 grid of row and column electrodes implies. The resolution is typically on the order of 960 counts per inch, or greater. The exact resolution is determined by the sensitivity of the components, the spacing between the electrodes 12, 14 on the same rows and columns, and other factors that are not material to the present invention.

The process above is repeated for the Y or column electrodes 14 using a P, N generator 24

Although the CIRQUE® touchpad described above uses a grid of X and Y electrodes 12, 14 and a separate and single sense electrode 16, the sense electrode can actually be the X or Y electrodes 12, 14 by using multiplexing.

### BRIEF SUMMARY OF THE INVENTION

In a first embodiment, the present invention is system and method for extending a sensitivity range of a touch and proximity sensor that uses mutual capacitance sensing, the system and method providing projecting electrodes that generate an electric field in a three dimensional volume of space above a touch and proximity sensor to thereby enable the touch and proximity sensor to accurately detect the presence of one or more objects at a greater distance as compared to a touch and proximity sensor that does not have the projecting electrodes to generate a stronger electric field.

These and other objects, features, advantages and alternative aspects of the present invention will become apparent to those skilled in the art from a consideration of the following detailed description taken in combination with the accompanying drawings.

### BRIEF DESCRIPTION OF THE SEVERAL VIEWS OF THE DRAWINGS

FIG. 1 is a block diagram of the components of a capacitance-sensitive touchpad as made by CIRQUE® Corporation and which can be operated in accordance with the principles of the present invention.

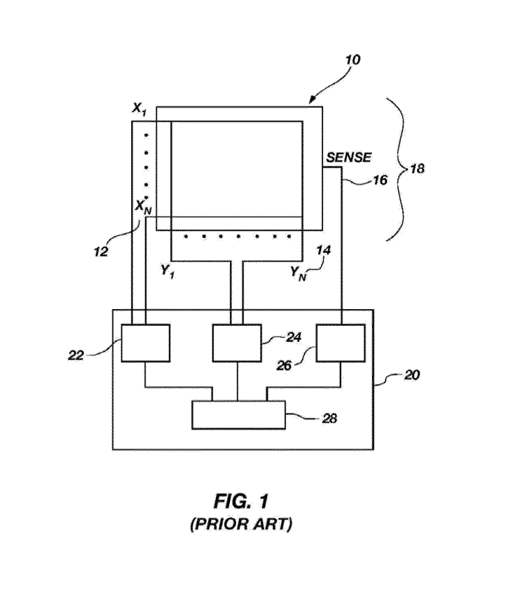

FIG. 2 is a block diagram of a first embodiment of the present invention showing off-board projection electrodes.

FIG. 3 is a block diagram of a first embodiment of the present invention showing off-board projection electrodes that are segmented.

FIG. 4 is a block diagram of a first embodiment showing that the location of the different projector electrode segments may also be modified.

FIG. 5 is a block diagram of a second embodiment showing that the projector electrodes may all be on-board electrodes.

FIG. 6 is a block diagram of a second embodiment showing that it is possible to combine both off-board and on-board projector electrodes segments in a single touch and proximity sensor.

FIG. 7 is a block diagram of a close-up view of projector electrodes disposed within gaps between the X and Y electrodes of the touch sensor.

### DETAILED DESCRIPTION OF THE INVENTION

Reference will now be made to the drawings in which the various elements of the present invention will be given numerical designations and in which the invention will be discussed so as to enable one skilled in the art to make and use the invention. It is to be understood that the following description is only exemplary of the principles of the present invention, and should not be viewed as narrowing the claims which follow.

It should be understood that use of the term “touch sensor” throughout this document may be used interchangeably with “proximity sensor”, “touch and proximity sensor”, “touch panel”, “touchpad” and “touch screen”, except when explicitly distinguished from the other terms.

The present invention is directed to improving or extending a range of operation of a touch sensor that may also be capable of operating as a proximity sensor. A touch sensor may be limited in a detection range and only be capable of detecting objects that make physical contact with a touch sensitive surface. However, in a first embodiment of the invention, a touch sensor may be modified in order to include an ability to sense one or more objects before they make contact with the touch sensor, and may be referred to in this document as a touch and proximity sensor.

The ability of a touch and proximity sensor to be able to detect objects before they make contact with a touch sensitive surface using capacitance sensing technology may be a function of the strength of an electric field that is generated above the touch sensitive surface by electrodes in the touch and proximity sensor. An object that perturbs or influences the electric field generated by the touch and proximity sensor may be detectable. It may follow that the further that an electric field can be generated from the touch and proximity sensor, the further an object may be detected away its surface and its movement tracked.

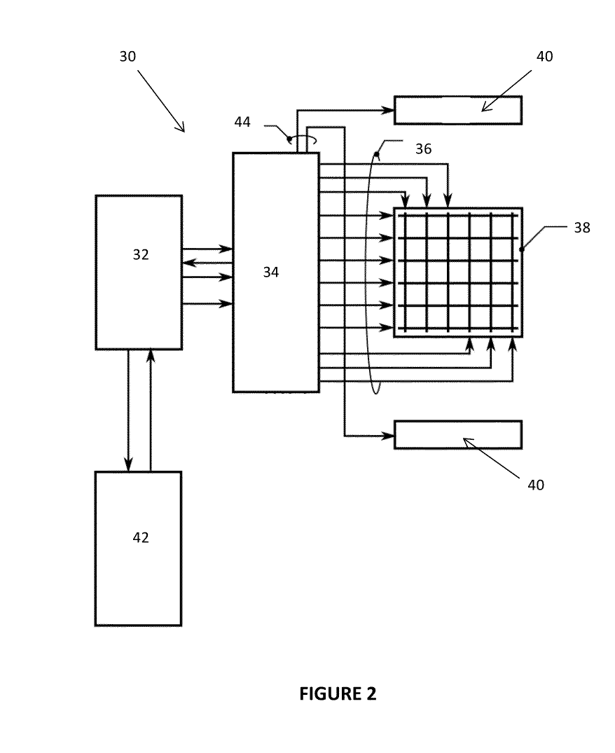

A touch and proximity sensor that may be used to implement the principles of the first embodiment of the present invention is shown in a block diagram in FIG. 2. The components of the first embodiment of a touch and proximity sensor 30 may include a microcontroller 32 coupled to a touch and proximity sensing capacitance detection circuit 34. The capacitance detection circuit 34 may have electrodes 36 that are coupled to an electrode grid that may be arranged in a co-planar and orthogonal arrangement commonly referred to as an X and Y electrode grid that may be referred to hereinafter as a touch sensor 38. Operation of the touch and proximity sensor 30 may be enhanced in this first embodiment by adding additional metal electrodes which may be conductive surfaces that are driven by electrodes 36 that are receiving drive signals from the capacitance detection circuit 34.

It should be understood that the touch and proximity sensor 30 may be in communication with a host 42. The host 42 may receive the touch and proximity data. The host 42 may be any system that is capable of receiving or using the touch and proximity data of the touch and proximity sensor 30. For example, the host 42 may be a portable electronic appliance such as a cellular telephone, a smartphone or a tablet computer, or it may be a stationary appliance such as a desktop computer, an automated teller machine (ATM) or a kiosk.

In the first embodiment, electrical field projecting electrodes or just “projector electrodes” may be arranged in different physical layouts or configurations. In the first embodiment, a first configuration for projector electrodes 40 and shown in FIG. 2 may be an off-board projector. An off-board projector may have projector electrodes 40 that are not disposed among or interspersed within the electrodes of the touch sensor 38 but are instead disposed around the perimeter of the touch sensor.

The projector electrodes 40 may have several features that may be important to the present invention. For example, the projector electrodes 40 may be wires or they may be planar electrodes. The projector electrodes 40 may create an electric field using whatever drive signal is provided by the capacitance detection circuit 34. The shape of the electric field may be influenced by the shape of the projector electrodes 40. The shape of the projector electrodes 40 may be an elongated rectangle. However, the shape may vary in order to achieve specific operational characteristics without departing from the scope of the present invention.

The projector electrodes 40 may be disposed in a symmetric or a non-symmetric arrangement around the touch sensor 38. However, symmetric placement of the projector electrodes 40 may enable a detectable object to be detected at a same distance from any outer edge or perimeter of the touch sensor 38. While FIG. 2 shows the projector electrodes 40 above and below the touch sensor 38, the projector electrodes 40 may be disposed to the right and left, or both above, below, right and left of the touch sensor.

It is noted that symmetry of the projector electrodes 40 around the touch sensor 38 may only be important when trying to achieve uniformity of detection distance around the touch sensor. Accordingly, the first embodiment may be operated using a single projector electrode 40 or a plurality of projector electrodes.

Another aspect of the first embodiment may be the size defined as the area of the projector electrodes 40 when they are formed as planar surfaces and not as only wires. When there is more than on projector electrode, the projector electrodes 40 may be equal in area to the area that is bounded by the electrode grid on the touch sensor 38. More specifically, the area of the touch sensor 38 is defined as the area within the X and Y electrodes that define the outer boundaries of the touch sensor. The total area of the touch sensor 38 may then be divided equally among the projector electrodes 40 such that the sum of the area of the projector electrodes is approximately equal to the area of the touch sensor 38.

It should be understood that the projector electrodes 40 may have a total area that is above or below the total area of the touch sensor 38 and still be within the scope of the present invention.

The purpose in making the areas of the projector electrodes 40 approximately or substantially equal to the area of the touch sensor 38 may be that when the areas are substantially equal, the electric field of the projector electrodes may have a maximum effect on the distance at which a detectable object may be detected by the touch sensor. In other words, the distance performance of the touch sensor 38 may be maximized to the greatest degree when the areas are approximately equal. Making the area of the projector electrodes 40 less than or greater than the area of the touch sensor 38 may not improve or may have less improvement on the distance performance of the touch and proximity sensor 30.

Accordingly, the projector electrodes 40 may improve performance of the touch sensor 38, but only up to the point at which the areas of the touch sensor and the projector electrodes are approximately equal.

It should be understood that the distance of the projector electrodes 40 from the touch sensor 38 may be exaggerated in FIG. 2, and should not be considered as an accurate or limiting depiction of the actual distance of the projector electrodes from the touch sensor.

The projector electrodes 40 may all be adjacent to the touch sensor 38 so that the electric field generated by the projector electrodes may have its greatest effect on the sensitivity of the touch sensor. It should be understood that sensitivity may refer to distance sensitivity, directional sensitivity or both.

The distance of each of the projector electrodes 40 from an edge of the touch senor 38 may be modified in order to change the distance sensitivity of the touch sensor or to modify directional sensitivity. In other words, the location and the strength of the electric fields generated by each of the projector electrodes 40 may be modified in order to have an effect on distance sensitivity and directional sensitivity or both.

The capacitance detection circuit 34 may be electrically coupled to the projector electrodes 40 via pathway electrodes 44. There may be a unique pathway electrode 44 to each of the projector electrodes 40, or the pathway may be shared.

The drive signal that is generated from the capacitance detection circuit 34 to the projector electrodes 40 may vary depending on a mode of operation of the touch and proximity sensor 30. For example, when operating in a proximity detection and/or tracking mode, the touch and proximity sensor 30 may use the projector electrodes 40. However, in a close proximity or touch detection and/or tracking mode, the touch and proximity sensor 30 may not use the projector electrodes 40. The projector electrodes 40 may not be used in order to save on power. Another reason for not using the projector electrodes 40 is that they may interfere with touch sensitivity or operation of the touch sensor 38.

As stated previously, when the projector electrodes 40 are in operation, they may receive a drive signal. The drive signal may be the same drive signal that is sent to drive electrodes in the touch sensor 38. In contrast, when the projector electrodes 40 are not in operation, they may be electrically floating or grounded. The state of the projector electrodes 40 may be selected in order to minimize interference, decrease power use or for other reasons.

In another aspect of the present invention, the electric field generated by the projector electrodes 40 may be a controllable electric field. For example, the projector electrodes 40 may be used to steer or direct the electric field as it extends outwards in order to have increased directional sensitivity of the touch sensor 38. For example, if there are two projector electrodes 40, the signal one of the projector electrode may be made stronger than the signal on a different projector electrode. The result may be an electric field that is not symmetrical, but instead extends further out from the projector electrode having the stronger signal.

The purpose of making the signal on one projector electrode 40 stronger than on another projector electrode is that distance sensitivity is then increased in the direction of the projector electrode having the stronger signal. This may be useful when detection from a particular direction is more important than detection of an object approaching the touch sensor 38 from another direction.

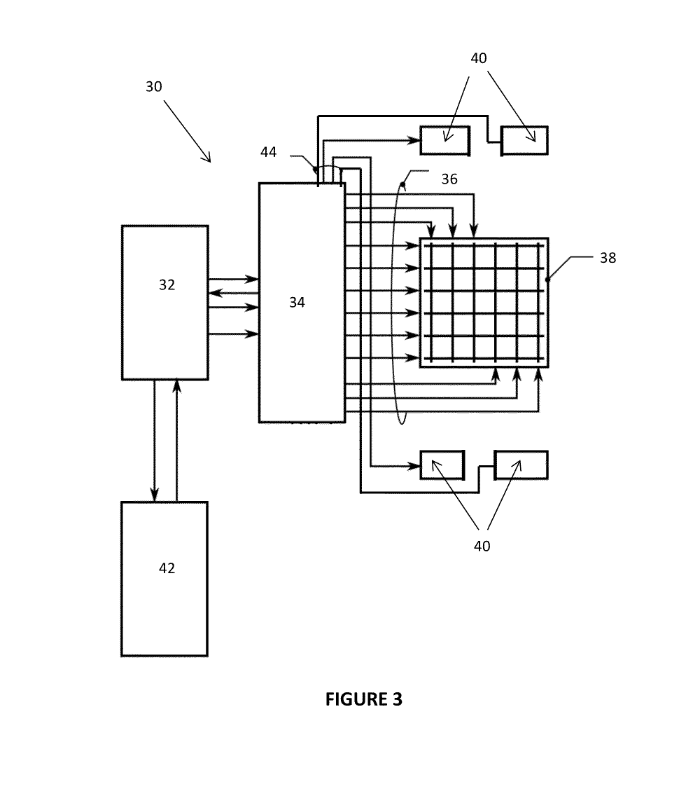

FIG. 3 shows another aspect of the first embodiment. In this figure, the projector electrodes 40 may be segmented. Different segments of the projector electrodes 40 may be activated at different times in order to change directional sensitivity, the shape of the electric field, or other aspects of operation of the touch and proximity sensor 30. The number of segments should not be considered as limited by the example shown in FIG. 3. More projector electrode 40 segments may be used in each location. Furthermore, the number of projector electrode 40 segments may not be equal on different sides of the touch sensor 38. This may enable an inherent directional sensitivity by just activating all of the projector electrode 40 segments.

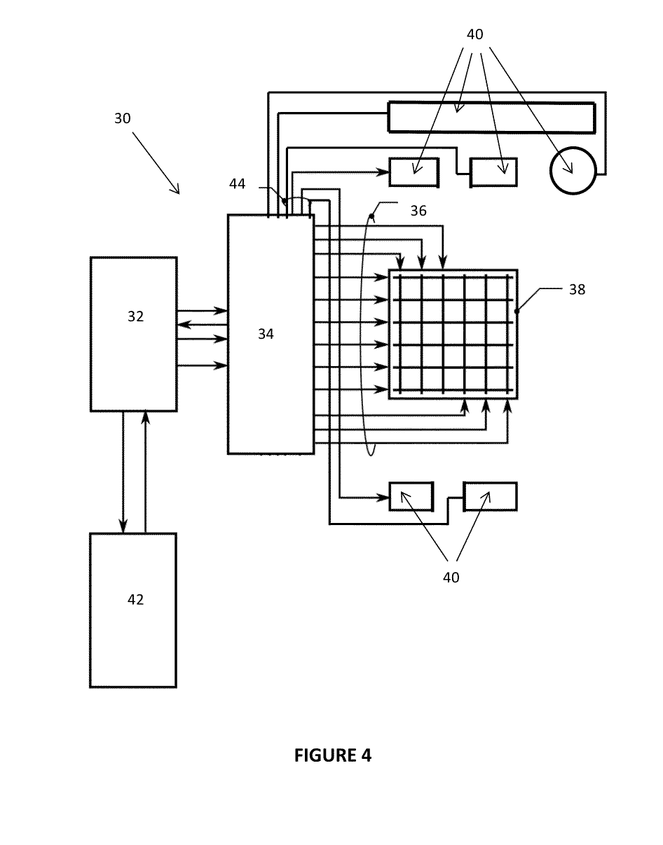

FIG. 4 shows in another aspect of the first embodiment that the location of the different projector electrode 40 segments may also be modified. For example, the projector electrode 40 segments may be arranged in different patterns or they may have different geometrical shapes as shown. Thus the shape of the projector electrode 40 segments and the layout may both be used to modify the sensitivity of the touch sensor 38.

In another aspect of the present invention, the projector electrodes 40 may be comprised of a solid planar surface or a mesh material. What is important is that the projector electrodes 40 be capable of generating the desired electric field.

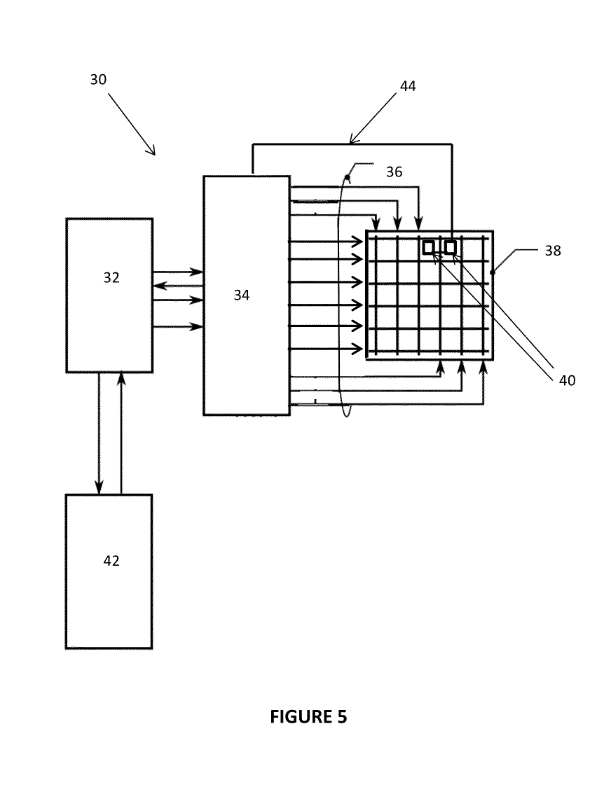

FIG. 5 is a block diagram of a second embodiment of the present invention. In the second embodiment of the present invention, the projector electrodes 40 may all be on-board electrodes, wherein the projector electrodes 40 are not separate from the substrate of the touch sensor 38 but may all be within the boundaries of the touch sensor. Thus the same substrate used for the X and Y electrode grid may also be used for the projector electrodes 40. The projector electrodes 40 may be co-planar with the electrodes of the touch sensor 38 or they may be disposed on a different plane or layer of a substrate.

In this second embodiment, the space or the gaps between the X and Y electrodes of the touch sensor 38 may be at least partially filled with the projector electrodes 40. Any number of the gaps may be filled with projector electrodes 40.

In this second embodiment, the projector electrodes 40 are segmented but coupled together using vias or other means of coupling to form a large but segmented projector electrode. It should be understood that the projector electrodes 40 may operate as one single large projector electrode or as individually controllable segments. In addition, there may be even more than one segment of the projector electrodes 40 within each gap.

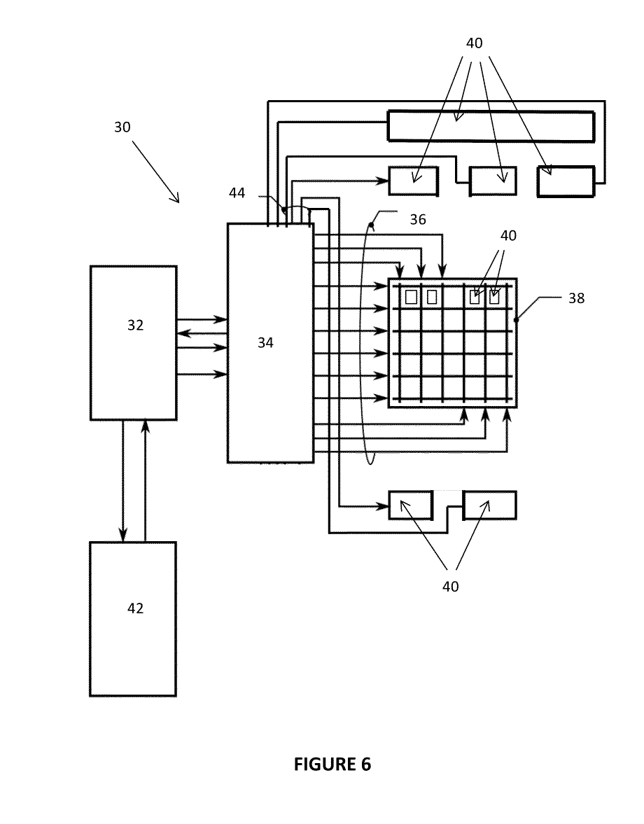

In an alternative embodiment shown in FIG. 6, the present invention may combine both off-board and on-board projector electrodes 40 segments in a single touch and proximity sensor 30. In such an arrangement, the segmented projector electrodes 40 may be formed outside of the boundary of the X and Y electrodes of the touch sensor 38 but may or may not be coupled to the segments that are inside the boundaries of the touch sensor.

It is noted that copper, ITO, steel and aluminum are all suitable materials for the projector electrodes 40. Thus, all conductive materials may be suitable for the projector electrodes 40.

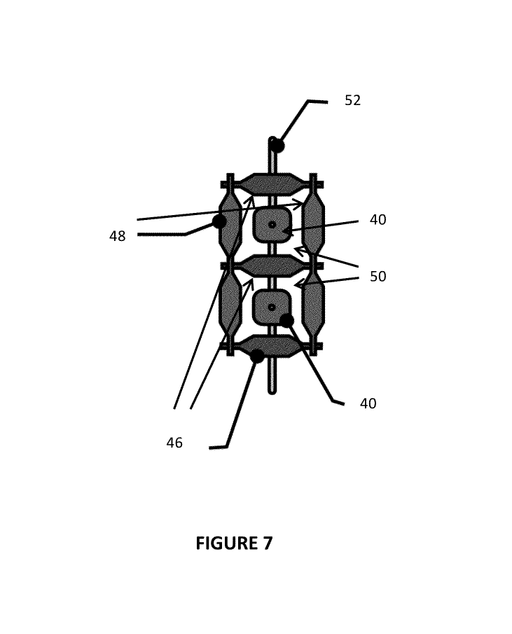

FIG. 7 is a close-up top view of a small portion of X and Y electrodes of a touch sensor 38. The touch sensor 38 shows two gaps 50 and an example of how the plurality of projector electrode 40 segments may be disposed in the gaps between the X and Y electrodes 46, 48 of the touch sensor 38. FIG. 5 shows a plurality of X electrodes 46 and a plurality of Y electrodes 48. The X electrodes 46 may be on a first plane, the Y electrodes 48 may be on a second plane, the projector electrodes 40 may be on the first or the second plane, and a projector electrode interconnect 52 may be on a fourth plane.

A ground plane may be inserted between the fourth plane of the projector electrode interconnect 52 and the first and second planes. The ground plane may be used to reduce the effect of the projector interconnect 52 on the touch sensor 38. There may also be more than one projector electrode interconnect 52 present if one or more of the projector electrode 40 segments are operating independently of each other.

Those skilled in the art will readily appreciate that many modifications are possible in the example embodiments without materially departing from this first embodiment or the invention. Accordingly, all such modifications are intended to be included within the scope of this disclosure as defined in the following claims. It is the express intention of the applicant not to invoke 35 U.S.C. §112, paragraph 6 for any limitations of any of the claims herein, except for those in which the claim expressly uses the words ‘means for’ together with an associated function.

What is claimed is:

1. A system for increasing sensitivity of a capacitance sensitive proximity sensor, said system comprised of:
touch sensor including a substantially orthogonal array of X and Y electrodes disposed on two layers of a touch sensor substrate, the X and Y electrodes being capable of functioning as drive and sense electrodes;
at least one projector electrode disposed adjacent to the touch sensor so as to generate an electric field that is detectable by the touch sensor; and
a capacitance detection circuit for sending signals to and receiving signals from the touch sensor and the at least one projector electrode.

2. The system as defined in claim 1 wherein the system is further comprised of a plurality of projector electrodes, one of the projector electrodes disposed adjacent to each edge of the touch sensor.

3. The system as defined in claim 1 wherein the system is further comprised of the touch sensor and the at least one projector electrode having substantially equal areas.

4. The system as defined in claim 1 wherein the at least one projector electrode is a rectangle having a long side that is parallel to an edge of the touch sensor.

5. The system as defined in claim 1 wherein the at least one projector electrode is further comprised of four projector electrodes, each of the four projector electrodes disposed with a long side that is parallel to an edge of the touch sensor and at equal distances from the touch sensor.

6. The system as defined in claim 1 wherein the at least one projector electrode is comprised of a plurality of projector electrodes, wherein each of the projector electrodes has an outline that is different from the other projector electrodes.

7. The system as defined in claim 1 wherein the at least one projector electrode is comprised of a plurality of projector electrodes, wherein a distance of each of the plurality of projector electrodes from the touch sensor is modified, wherein each of the plurality of projector electrodes is moved farther from or closer to the touch sensor in order to modify sensitivity of the touch sensor.

8. The system as defined in claim 1 wherein the at least one projector electrode is further comprised of a plurality of projector electrodes disposed co-planar with and within gaps formed by the orthogonal array of X and Y electrodes on the touch sensor so as to generate an electric field that is detectable by the touch sensor, wherein the plurality of projector electrodes are all coupled to each other using a projector interconnect so as to form a single segmented projector electrode.

9. A system for increasing sensitivity of a capacitance sensitive proximity sensor, said system comprised of:
touch sensor including a substantially orthogonal array of X and Y electrodes disposed on two layers of a touch sensor substrate, the X and Y electrodes being capable of functioning as drive and sense electrodes;
a plurality of projector electrodes disposed co-planar with and within gaps formed by the orthogonal array of X and Y electrodes on the touch sensor so as to generate an electric field that is detectable by the touch sensor, wherein the plurality of projector electrodes are all coupled to each other using a projector interconnect so as to form a single segmented projector electrode; and
a capacitance detection circuit for sending signals to and receiving signals from the touch sensor and the plurality of projector electrodes.

10. The system as defined in claim 9 wherein the system is further comprised of the touch sensor and the plurality of projector electrodes having substantially equal areas.

11. A method for increasing sensitivity of a capacitance sensitive proximity sensor, said system comprised of:
providing a touch sensor including a substantially orthogonal array of X and Y electrodes disposed on two layers of a touch sensor substrate, the X and Y electrodes being capable of functioning as drive and sense electrodes;
providing at least one projector electrode disposed adjacent to the touch sensor so as to generate an electric field that is detectable by the touch sensor; and
providing a capacitance detection circuit for sending signals to and receiving signals from the touch sensor and the at least one projector electrode.

12. The method as defined in claim 11 wherein the method further comprises providing a plurality of projector electrodes, wherein at least one of the projector electrodes is disposed adjacent to each edge of the touch sensor in order to increase sensitivity of the touch sensor.

13. The method as defined in claim 11 wherein the method further comprises making the touch sensor and the at least one projector electrode with substantially equal areas in order to maximize sensitivity of the touch sensor.

14. The method as defined in claim 11 wherein the method further comprises providing at least four projector electrodes, wherein each of the four projector electrodes is disposed with a long side that is parallel to an edge of the touch sensor and at equal distances from the touch sensor in order to balance sensitivity equally around the touch sensor.

15. The method as defined in claim 11 wherein the method further comprises providing a plurality of projector electrodes, and wherein a distance of the plurality of projector electrodes relative to the touch is modified in order to create in imbalance in sensitivity around the touch sensor.

16. The method as defined in claim 11 wherein the method further comprises providing a plurality of projector electrodes, wherein a shape of the projector electrodes may have an outline that is different from the other projector electrodes in order to modify sensitivity of the touch sensor.

17. The method as defined in claim 11 wherein the method further comprises providing a plurality of projector electrodes, wherein a distance of each of the plurality of projector electrodes from the touch sensor is modified, wherein each of the plurality of projector electrodes is moved farther from or closer to the touch sensor in order to modify sensitivity of the touch sensor.

18. The method as defined in claim 11 wherein the method further comprises:
providing a plurality of projector electrodes outside a perimeter of the touch sensor; and
providing a plurality of projector electrodes within the perimeter and co-planar with the touch sensor and within gaps formed by the orthogonal array of X and Y electrodes on the touch sensor so as to generate an electric field that is detectable by the touch sensor, wherein the plurality of projector electrodes are all coupled to each other using a projector interconnect so as to form a single segmented projector electrode.

19. A system for increasing sensitivity of a capacitance sensitive proximity sensor, said system comprised of:
touch sensor including a substantially orthogonal array of X and Y electrodes disposed on two layers of a touch sensor substrate, the X and Y electrodes being capable of functioning as drive and sense electrodes;
at least one projector electrode disposed adjacent to the touch sensor so as to generate an electric field that is detectable by the touch sensor; and
a capacitance detection circuit for sending signals to the at least one projector electrode and for receiving signals from the touch sensor.
